(19) United States
(12) Patent Application Publication
(10) Pub. No.: US 2026/0269903 A1
(43) Pub. Date: Sep. 10, 2026

(54) CHANNEL STATE INFORMATION REPORTING IN SUBBAND FULL DUPLEX (SBFD)

(71) Applicant: MediaTek Singapore Pte. Ltd., Singapore (SG)

(72) Inventors: Sumaila Anning MAHAMA, Cambridge (GB); Mohammed S Aleabe AL-IMARI, Cambridge (GB)

(21) Appl. No.: 19/163,590

(22) PCT Filed: Feb. 19, 2024
(86) PCT No.: PCT/CN2024/077506

§ 371 Date: Sep. 9, 2025

Related U.S. Application Data
(60) Provisional application No. 63/495,122, filed on Apr. 10, 2023.

(51) Int. Cl. H04B 7/06; H04L 5/00; H04L 5/14; H04W 24/10

(52) U.S. Cl. CPC H04B 7/0626; H04L 5/0044; H04W 24/10; H04L 5/14

(57) ABSTRACT

Techniques pertaining to channel state information (CSI) reporting in subband full duplex (SBFD) are described. Such techniques include configuring a user equipment (UE) to generate separate channel or interference measurement values for individual slots of each slot type of multiple slot types based on periodic or semi-persistent channel state information-reference signal (CSI-RS) resources in the slots for reporting, wherein the configuring is performed when a time restriction for measurements parameter is set to not configured. The techniques further include receiving separate channel state information (CSI) reports from the UE of the separate channel or interference measurement values.

### CROSS REFERENCE TO RELATED PATENT APPLICATION(S)

The present disclosure is part of a non-provisional application claiming the priority benefit of U.S. patent application Ser. No. 63/495,122, filed 10 Apr. 2023, the content of which herein being incorporated by reference in its entirety.

### TECHNICAL FIELD

The present disclosure is generally related to mobile communications and, more particularly, to techniques for channel state information (CSI) reporting.

### BACKGROUND

Unless otherwise indicated herein, approaches described in this section are not prior art to the claims listed below and are not admitted as prior art by inclusion in this section. UEs may use channel state information-reference signal (CSI-RS) resources to measure channel state information (CSI) when receiving downlink transmissions from a network node (e.g., a gNodeB (gNB). In turn, the UEs may report such CSI to the network node in uplink transmissions. In 3GPP Release 19, SBFD UEs are full-duplex, meaning that such UEs are able to transmit and receive data simultaneously over resources that overlap in time. Prior to 3GPP Release 19, UE are half-duplex, this means while gNodeBs are able to transmit and receive data simultaneously at any given time, UEs are capable of only transmitting or receiving data at any given time. Thus, SBFD UEs under 3GPP Release 19 are able to provide higher maximum user throughput with two-way data and lower latency. However, because SBFD uses slots of different slot types for data transmissions, there may be a need for new solutions for conducting CSI measurements and reporting in SBFD.

### SUMMARY

The following summary is illustrative only and is not intended to be limiting in any way. That is, the following summary is provided to introduce concepts, highlights, benefits, and advantages of the novel and non-obvious techniques described herein. Select implementations are further described below in the detailed description. Thus, the following summary is not intended to identify essential features of the claimed subject matter, nor is it intended for use in determining the scope of the claimed subject matter.

An objective of the present disclosure is to propose solutions or schemes that address the issue(s) described herein. More specifically, various schemes proposed in the present disclosure are believed to provide solutions that resolve several problems associated with CSI reporting by SBFD UEs under the current 3GPP specifications.

In one aspect, a method may include configuring, by a processor, an activation command to direct a UE to select multiple semi-persistent CSI reporting configurations or settings for use by the UE on a physical uplink control channel (PUCCH) for CSI reporting. The method may further include sending, by the processor, the activation command to the UE to configure the UE to generate one or more CSI reports using one or more CSI-RS resources on the PUCCH based on the multiple semi-persistent reporting configurations or settings.

In another aspect, an apparatus may include a transceiver and a processor coupled to the transceiver. The transceiver may be configured to communicate wirelessly. The processor may determine whether a CSI-RS resource configuration that is used for generating a CSI measurement based on one or more CSI-RS resources in a slot includes one or more portions of the slot that fall outside of one or more downlink subbands of the slot. Subsequently, the processor may be configured, in response to determining that the CSI-RS resource configuration includes one or more portions that fall outside of one or more downlink subbands of the slot, to designate such one or more portions of the slot as an invalid allocation that is excluded from the CSI-RS resource configuration for the generation of the CSI measurement.

In yet another aspect, a method may include configuring, by a processor, a UE to generate separate channel or interference measurement values for individual slots of each slot type of multiple slot types based on periodic or semi-persistent CSI-RS resources in the slots for reporting, wherein the configuring is performed when a time restriction for measurements parameter is set to not configured. The method may further include receiving, by the processor, separate CSI reports from the UE of the separate channel or interference measurement values.

It is noteworthy that, although the description provided herein may be in the context of certain radio access technologies, networks, and network topologies such as 5G/NR/Beyond Fifth-Generation (B5G) mobile communications, the proposed concepts, schemes and any variation(s)/derivative(s) thereof may be implemented in, for and by other types of radio access technologies, networks and network topologies such as, for example and without limitation, Long-Term Evolution (LTE), LTE-Advanced, LTE-Advanced Pro, Internet-of-Things (IoT), Narrow Band Internet of Things (NB-IoT), Industrial Internet of Things (IIoT), vehicle-to-everything (V2X), and non-terrestrial network (NTN) communications. Thus, the scope of the present disclosure is not limited to the examples described herein.

### BRIEF DESCRIPTION OF THE DRAWINGS

The accompanying drawings are included to provide a further understanding of the disclosure and are incorporated in and constitute a part of the present disclosure. The drawings illustrate implementations of the disclosure and, together with the description, serve to explain the principles of the disclosure. It is appreciable that the drawings are not necessarily in scale as some components may be shown to be out of proportion than the size in actual implementation in order to clearly illustrate the concept of the present disclosure.

FIG. 1 is a diagram of an example network environment in which various proposed schemes in accordance with the present disclosure may be implemented.

FIG. 2 illustrates some aspects related to an example proposed scheme in accordance with the present disclosure.

FIG. 3 illustrates some other aspects related to an example proposed scheme in accordance with the present disclosure.

FIG. 4 illustrates some aspects of an example proposed scheme in accordance with the present disclosure.

FIG. 5 illustrates some additional aspects of an example proposed scheme in accordance with the present disclosure.

FIG. 6 illustrates some further aspects of an example proposed scheme in accordance with the present disclosure.

FIG. 7 is a block diagram of an example communication system in accordance with an implementation of the present disclosure.

FIG. 8 is a flowchart of a first example process in accordance with an implementation of the present disclosure.

FIG. 9 is a flowchart of a second example process in accordance with an implementation of the present disclosure.

FIG. 10 is a flowchart of a third example process in accordance with an implementation of the present disclosure.

### DETAILED DESCRIPTION OF PREFERRED IMPLEMENTATIONS

Detailed embodiments and implementations of the claimed subject matters are disclosed herein. However, it shall be understood that the disclosed embodiments and implementations are merely illustrative of the claimed subject matters which may be embodied in various forms. The present disclosure may, however, be embodied in many different forms and should not be construed as limited to the exemplary embodiments and implementations set forth herein. Rather, these exemplary embodiments and implementations are provided so that the description of the present disclosure is thorough and complete and will fully convey the scope of the present disclosure to those skilled in the art. In the description below, details of well-known features and techniques may be omitted to avoid unnecessarily obscuring the presented embodiments and implementations.

### Overview

Implementations in accordance with the present disclosure relate to various techniques, methods, schemes and/or solutions pertaining to CSI reporting in SBFD. According to the present disclosure, a number of possible solutions may be implemented separately or jointly. That is, although these possible solutions may be described below separately, two or more of these possible solutions may be implemented in one combination or another.

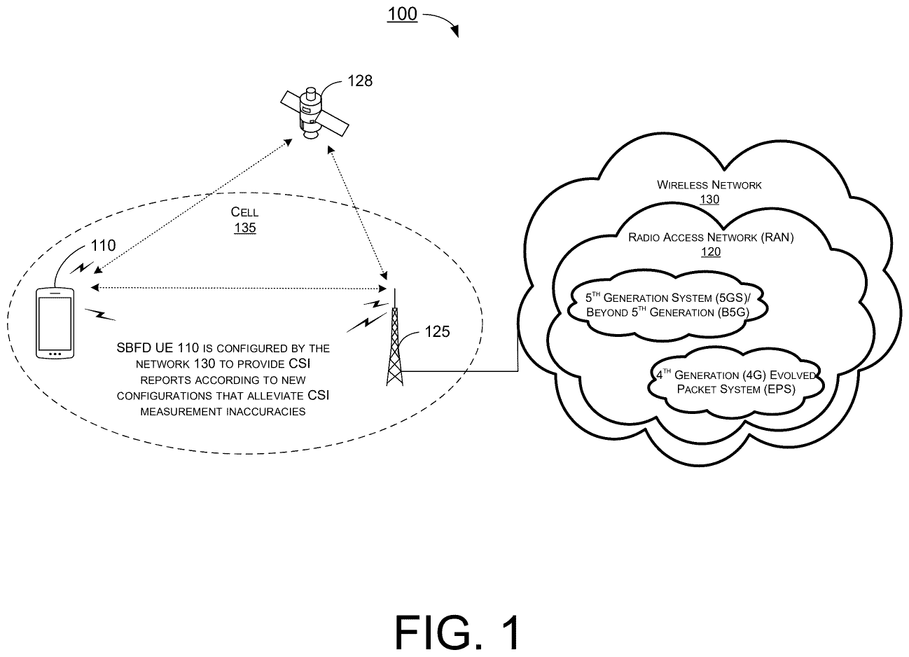

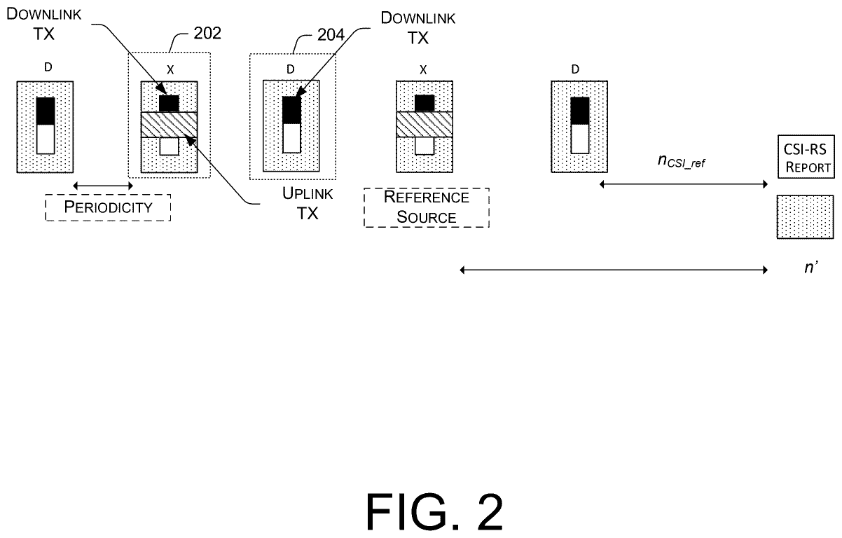

FIG. 1 illustrates an example network environment 100 in which various solutions and schemes in accordance with the present disclosure may be implemented. FIG. 2-FIG. 10 illustrate examples of implementation of various proposed schemes in network environment 100 in accordance with the present disclosure. The following description of various proposed schemes is provided with reference to FIG. 1-FIG. 10.

As shown in FIG. 1, network environment 100 may include a UE 110 in wireless communication with a RAN 120 (e.g., a 5G NR mobile network, a B 5G mobile network, or another type of network such as an NTN). UE 110 may be in wireless communication with RAN 120 via a network node 125 (e.g., an eNodeB, gNodeB, or transmit-receive point (TRP)) and/or a non-terrestrial network node 128 (e.g., a satellite). That is, UE 110 may be within coverage of a cell 135 associated with terrestrial network node 125 or non-terrestrial network node 128. RAN 120 may be a part of a network 130. In network environment 100, UE 110 and network 130 (via network node 125 of RAN 120) may implement various schemes that solve several problems associated with CSI reporting in SBFD under the current 3GPP specifications.

CSI reporting by a UE, such as the UE 110, may be periodic, semi-persistent, or aperiodic depending on the nature of the underlying channel state information-reference signal (CSI-RS) resources. In CSI reporting, a UE may perform a CSI measurement based on one or more CSI-RS resources that are provided by a network node to the UE. Subsequently, the UE may report the CSI measurement to the network node. For example, a CSI measurement may be a channel measurement, an interference measurement, etc. When the CSI reporting is based on aperiodic CSI-RS resources, each CSI measurement and reporting may be performed for a SBFD slot or a non-SBFD slot at any given time. Slots are subunits of data transmission frames that are used for uplink and downlink data transmissions between a UE and a network node. A SBFD slot, also referred to as a partitioned slot, is a slot that is partitioned into including both uplink and downlink subbands. In contrast, a non-SBFD slot, also referred to as a non-partitioned slot, is a slot that is not partitioned into including both uplink and downlink subbands. For example, the non-SBFD slot may be a slot that includes one or more downlink subbands but not one or more uplink subbands, or a slot that includes one or more uplink subbands but not one or more downlink subbands.

When CSI reporting is based on periodic or semi-persistent CSI-RS resources, CSI measurement and reporting are performed for multiple slots that include a mixture of SBFD slots and non-SBFD slots. As shown in FIG. 2, a CSI measurement that is conducted by a UE for a downlink transmission in a SBFD slot 202 may be affected by interference that results from an uplink transmission that is performed by another UE in the same SBFD slot. In contrast, a CSI measurement that is conducted by a UE for a downlink transmission in a non-SBFD slot 204 will not be impacted by any uplink transmission interferences for another UE, as the non-SBFD slot 204 is only used for the downlink transmission. Thus, any interference that occurs for a SBFD slot may be completely different from the interference that occurs for a non-SBFD slot. As a result, when a CSI measurement (e.g., an interference measurement) is performed over multiple slots that include a mixture of SBFD slots and non-SBFD slots, the CSI measurement may include a measured interference that is too high for a non-SBFD slot and too low for a SBFD slot, thereby creating a CSI measurement that is inaccurate. Therefore, in the case of periodic or semi-persistent CI-RS resources, there is a need for slot-specific CSI reporting in which the reported CSI measurements are not performed across a mixture of SBFD and non-SBFD slots.

In some instances, it is possible to perform slot-specific CSI reporting for periodic CSI-RS resources under the current 3GPP specifications. For example, in the current 3GPP specifications, a UE may be configured with a parameter (e.g., timeRestrictionForInterferenceMeasurements) from a network node when the UE is configured to perform interference measurements based on the CSI-RS resources in slots. Each of the individual slots may be a SBFD slot or a non-SBFD slot. For example, when this parameter is set to “configured”, the UE is restricted to perform each of its interference measurements for only a single slot rather than across multiple slots. Thus, regardless of whether the single slot is a SBFD slot or a non-SBFD slot, the interference measurement is accurate for that slot. Likewise, a UE may similarly receive an additional parameter (e.g., timeRestrictionForChannelMeasurements) from the network node when the UE is configured to perform channel measurements based on CSI-RS resources in slots, in which the additional parameter is set to “configured”. In such a case, the UE is restricted to performing each of its channel measurements for only a single slot rather than across multiple slots. Thus, when a UE is configured with such parameters, each CSI measurement (e.g., an interference measurement or a channel measurement) is always performed by the UE for a single slot, regardless of whether the CSI-RS received from the network node is periodic, semi-persistent, or aperiodic. In other words, when the parameter or the additional parameter is set to “configured”, slot-specific CSI reporting is possible under the current 3GPP specifications.

However, when the parameter or the additional parameter is set to “not configured”, the UE is restricted to performing interference or channel measurements across multiple resources up to and including a particular reference resource. These multiple resources, i.e., multiple slots, may include both SBFD slots and non-SBFD slots. For example, the multiple reference resources may include a particular reference resource, e.g., a particular slot, and a predetermined number of resources, e.g., slots, that precede the reference resource. This means that when the parameter or the additional parameter is set to “not configured”, slot-specific CSI reporting is not possible.

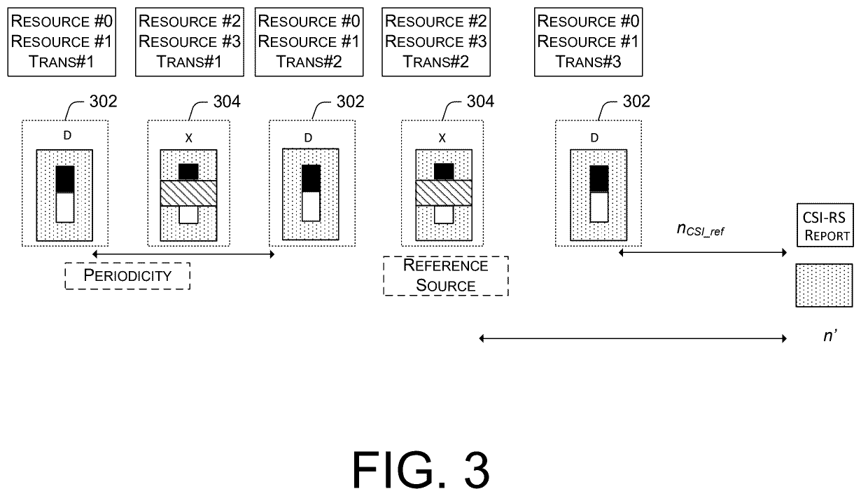

In other instances under the current 3GPP specification, each type of slot may be configured with specific CSI-RS resources according to the current 3GPP specifications to make slot-specific CSI reporting possible for periodic or semi-persistent CSI-RS resources on the physical uplink shared channel (PUSCH). For example, multiple reporting settings (e.g., CSI-ReportConfig settings) may be configured in which each reporting setting is linked to a CSI-RS resource configured on a specific type of slot. For example, as shown in FIG. 3, non-SBFD slots 302 may be configured with CSI-RS resources #0 and #1, while SBFD slots 304 may be configured with CSI-RS resources #2 and #3. In this way, one CSI measurement and reporting may be performed for the non-SBFD slots 302, and another CSI measurement and reporting may be performed for the SBFD slots 304.

However, an issue with such a configuration for semi-persistent reporting on the physical uplink control channel (PUCCH) may arise due to an activation restriction on semi-persistent reporting on the PUCCH as specified in 3GPP Technical Specification (TS) 38.214, Section 5.2.1.5.2. Under this activation restriction, while multiple CSI-RS resources may be configured for a particular slot, only a single CSI-RS resource configured for a slot may be activated at any given time for CSI reporting, i.e., the activation command is only capable of selecting one semi-persistent reporting configuration for use by the UE at a time on PUCCH. This activation restriction makes it impractical to share multiple CSI-RS resources across the two different types of slots for the purpose of semi-persistent reporting, thereby making slot-specific CSI-reporting for semi-persistent CSI-RS resources on the PUCCH infeasible.

Thus, there are several problems with the implementation of CSI reporting by SBFD UEs under the current 3GPP specifications. The first problem is that although multiple CSI reporting configurations are configurable for semi-persistent CSI reporting on the PUCCH, an activation command under the current 3GPP specification is only capable of selecting one CSI reporting configuration for use by the UE on PUCCH. Thus, to enable slot specific CSI reporting, an activation command that is capable of activating more than one CSI reporting configuration is needed. The second problem is that for periodic or semi-persistent CSI-RS resources, the configured CSI-RS resource configuration, for performing a CSI measurement, i.e., the configured frequency domain resources, may overlap with uplink subbands (UL-SB) on SBFD (partitioned) slots when the same CSI-RS resource configuration is applied to both SBFD (partitioned) and non-SBFD (non-partitioned) slot types. The third problem is that a UE under the current 3GPP specifications is configured to send a single value for each reported CSI measurement quantity that is based on periodic and/or semi-persistent CSI-RS resources. For accurate CSI measurement and reporting in SBFD, separate CSI reporting should be configured for partitioned (SBFD) and non-partitioned (non-SBFD) slots.

In a first proposed scheme, for semi-persistent CSI reporting on PUCCH, the network 130 may configure or activate multiple semi-persistent CSI reporting configurations and/or settings for the UE by configuring an activation command. In various instances, the network 130 may perform such configuration of the activation command and then send the activation command to the UE. In various embodiments, the configured activation command may be used to direct the UE to select multiple semi-persistent reporting configurations or settings for use by the UE on the PUCCH. For example, the activation command may configure the UE to select two reporting configurations or settings for use by the UE on the PUCCH based on two different slot types. In some embodiments, each reporting configuration or setting may be applied to a corresponding set of slots of multiple sets of slots, in which each corresponding set of slots is of a specific slot type. For example, one of the selected reporting configurations or settings may be used by the UE for CSI reporting on non-partitioned slots, and the other of the selected reporting configurations or settings may used by the UE for CSI reporting on partitioned slots. In such instances, the slot type of a slot is non-partitioned when an allocation of the resource blocks in the slot for CSI reporting by the network 130 only overlaps with non-partitioned symbols in the slot. Otherwise, the slot type of the slot is partitioned. This proposed scheme may address the first problem associated with the current implementation of CSI reporting by SBFD UEs.

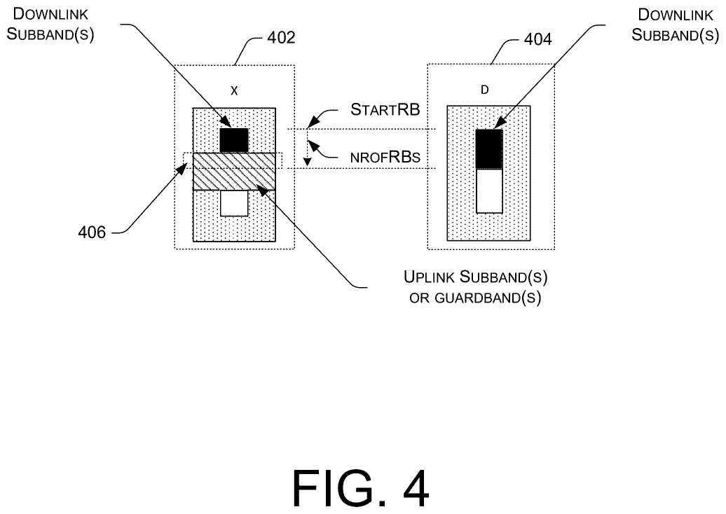

In a second proposed scheme, for periodic or semi-persistent CSI-RS resources, the UE may be configured by the network 130 to consider any portion of a frequency domain resource configuration, i.e., a CSI-RS resource configuration, that falls outside one or more downlink subbands in a partitioned slot as an invalid allocation. For example, as shown in FIG. 4, the CSI-RS resource configuration for performing CSI measurement may apply to slots of both partitioned and non-partitioned slot types, e.g., partitioned slot 402 and non-partitioned slot 404. The application of the CSI-RS resource configuration, which is based on a start resource block (startRB) and a number of RBs (nrofRBs) that increments from the startRB, to the partitioned slot 402 may result in a CSI-RS resource that includes one or more downlink portions (i.e., one or more downlink subbands) of the partitioned slot 402 that are used for performing a CSI measurement. However, the CSI-RS resource that results from such a CSI-RS resource configuration may also include at least one uplink portion (e.g., one or more uplink subbands) or at least one guardband portion (e.g., one or more guardbands) of the partitioned slot 402, such as the portion 406. However, because such at least one uplink portion or at least one guardband portion (e.g., portion 406) is outside of the one or more downlink subbands of the partitioned slot 402, the UE is configured to consider such portions to be an invalid allocation. Accordingly, the UE may exclude any invalid allocation that is outside of the one or more downlink subbands while generating the CSI measurement based on the CSI-RS resource configuration. In various embodiments, the CSI-RS resource configuration may include an allocation of a contiguous downlink subband or an allocation of multiple non-contiguous downlink subbands. For example, the CSI-RS resource configuration may be contiguous within a downlink subband. Furthermore, because the UE is configured to exclude invalid allocations, the UE may obtain an allocation of the multiple non-contiguous downlink subbands by excluding any CSI-RS resource in the CSI-RS resource configuration that overlap with one or more uplink subbands and/or one or more guardbands as an invalid allocation. This proposed scheme may address the second problem associated with the current implementation of CSI reporting by SBFD UEs.

In a third proposed scheme, the UE may be configured by the network 130 to perform channel measurements and send CSI reports for slots of each slot type based on periodic or semi-persistent CSI-RS resources in the slots. For example, the network 130 may perform such configuration by sending one or more configuration settings to the UE. In some embodiments, the UE may be configured to generate separate channel measurement values and send separate CSI reports for individual slots of each slot type of the multiple slot types when a time restriction for measurements parameter that the UE received from the network 130 is set to “not configured”. For example, the parameter may be the timeRestrictionForChannelMeasurements parameter.

In some embodiments, the UE is configured to perform separate channel measurement values for non-partitioned and partitioned slots within a configured periodicity, e.g., a time interval. In such embodiments, the slot type of a slot is non-partitioned when an allocation of the resource blocks in the slot for CSI reporting by the network 130 only overlaps with non-partitioned symbols in the slot. Otherwise, the slot type of the slot is partitioned.

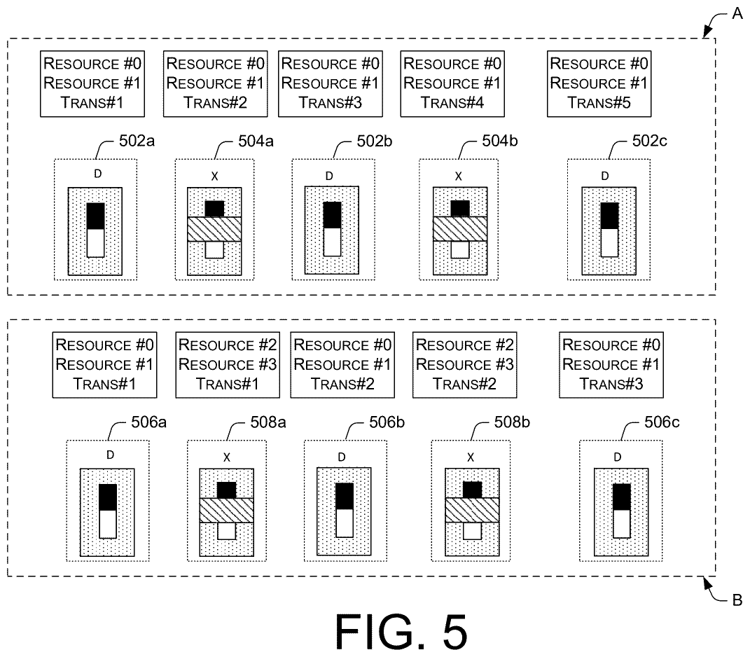

In some instances, the UE may be configured to generate separate channel measurement values and send separate CSI reports for periodic or semi-persistent CSI-RS resources that belong to the same CSI-RS resource set. For example, as shown in Part A of FIG. 5, a CIS-RS resource set of CIS-RS resources #0 and #1 may be present in two types of slots, i.e., partitioned slots and non-partitioned slots (e.g., non-partitioned slots 502a-502c and partitioned slots 504a and 504b). Thus, the UE may generate a first CSI report for the non-partitioned slot 502a by performing a channel measurement using one or more of the resources #0 and #1 in the non-partitioned slot 502a. Subsequently, the UE may generate a second CSI report for the partitioned slot 504a by performing a channel measurement using one or more of the resources #0 and #1 in the partitioned slot 504a, and so on and so forth. In this way, the UE may generate a separate CSI report that includes a channel measurement for each of the non-partitioned slots 502a-502c and the partitioned slots 504a and 504b.

In other embodiments, the UE may be configured to generate separate channel measurement values and send separate CSI reports for periodic or semi-persistent CSI-RS resources that belong to different CSI-RS resource sets. For example, as shown in Part B of FIG. 5, while each of the non-partitioned slots 506a-506c has a CSI-RS resource set that includes resources #0 and #1, each of the partitioned slots 508a and 508b has a different CSI-RS resource set that includes resources #2 and #3. Thus, by generating a separate channel measurement and sending a separate CSI report for each of the slots (e.g., the slots 506a-506c and 508a and 508b), the UE can generate separate channel measurement values and send separate CSI reports for CSI-RS resources that belong to different CSI-RS resource sets.

In additional embodiments, the UE may be configured to generate and report a corresponding single channel measurement value for multiple slots of each slot type (e.g., SBFD slot vs. non-SBFD slot). For example, the UE may report a first channel measurement value for multiple slots of a first slot type to the network 130 and report a second channel measurement value for multiple slots of a second slot type to the network 130. In such an example, if the UE is configured to provide CSI reports that include a channel measurement quantity cri-RSRP, the UE may report a first value in the form of cri-RSRP-0 for multiple slots of the first slot type and report a second value in the form of cri-RSRP-1 for multiple slots of the second slot type.

In such an example, the first value may be generated by averaging the individual channel measurement values of the non-partitioned slots (e.g., non-partitioned slots 502a-502c) to obtain a corresponding average channel measurement value for the non-partitioned slots as the first value. Likewise, the second value may be generated by averaging the individual channel measurement values of the partitioned slots (e.g., partitioned slots 504a and 504b) to obtain a corresponding average channel measurement value for the partitioned slots as the second value.

In some instances, the UE may report an initial value for the first type of slot to the network 130, and then report a differential value to the initial value that is used by the network 130 to determine the value for the second type of slot. In such instances, the differential value may be defined relative to the first and second report values as:

differentialReportValue=firstReportValue-secondReportValue

In other embodiments, the two reported channel measurement values may be included in a single CSI report. The sets of slots for which each channel measurement is generated may be indicated to the UE by a high-layer parameter, such as a parameter provided by Layer-1 or Layer-2, in which Layer-1 level refers to the physical layer in the 3GPP specifications, Layer- 2 level refers to the media access control (MAC) layer in the 3GPP specifications. However, in alternative embodiments, the UE may be configured by the network 130 to perform a single channel measurement across slots of both slot types. This proposed scheme may address the third problem associated with the current implementation of CSI reporting by SBFD UEs.

In a fourth proposed scheme, the UE may be configured by the network 130 to perform interference measurements and send CSI reports for individual slots of each slot type based on periodic or semi-persistent CSI-RS resources in the slots. In some embodiments, the UE may be configured to generate separate interference measurement values and send separate CSI reports for individual slots of each slot type of the multiple slot types when a time restriction for measurement parameters that the UE received from the network 130 is set to “not configured”. For example, the parameter may be the timeRestrictionForInterferenceMeasurements parameter.

In some embodiments, the UE is configured to perform separate interference measurement values for non-partitioned and partitioned slots within a configured periodicity, e.g., time interval. In such embodiments, the slot type of a slot is non-partitioned when an allocation of the resource blocks in the slot for CSI reporting by the network 130 only overlaps with non-partitioned symbols in the slot. Otherwise, the slot type of the slot is partitioned.

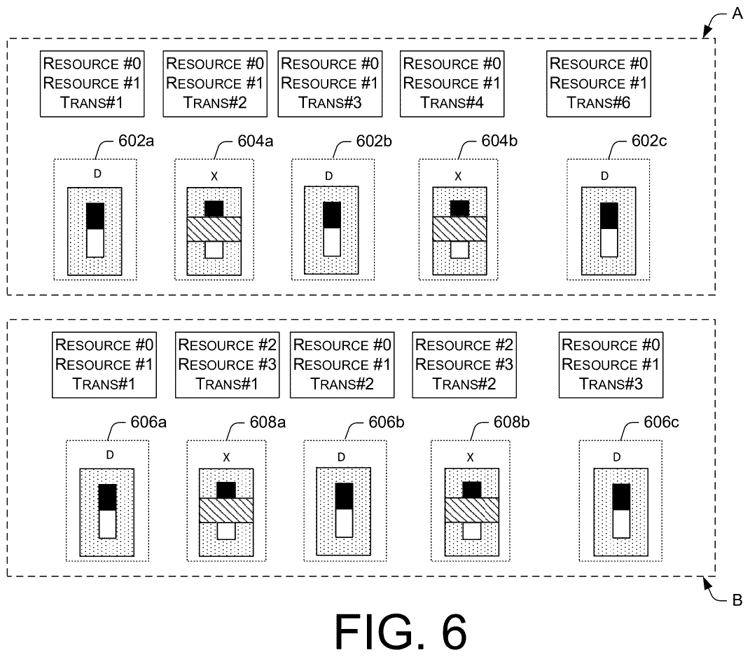

In some instances, the UE may be configured to generate separate interference measurement values and send separate CSI reports for periodic or semi-persistent CSI-RS resources that belong to the same CSI-RS resource set. For example, as shown in Part A of FIG. 6, a CIS-RS resource set of CIS-RS resources #0 and #1 may be present in two types of slots, i.e., partitioned slots and non-partitioned slots (e.g., non-partitioned slots 602a-602c and partitioned slots 604a and 604b). Thus, the UE may generate a first CSI report for the non-partitioned slot 602a by performing an interference measurement using one or more of the resources #0 and #1 in the non-partitioned slot 602a. Subsequently, the UE may generate a second CSI report for the partitioned slot 604a by performing an interference measurement using one or more of the resources #0 and #1 in the partitioned slot 604a, and so on and so forth. In this way, the UE may generate a separate CSI report that includes an interference measurement for each of the non-partitioned slots 602a-602c and the partitioned slots 604a and 604b.

In other embodiments, the UE may be configured to generate separate interference measurement values and send separate CSI reports for periodic or semi-persistent CSI-RS resources that belong to different CSI-RS resource sets. For example, as shown in Part B of FIG. 6, while each of the non-partitioned slots 606a-606c has a CSI-RS resource set that includes resources #0 and #1, each of the partitioned slots 608a and 608b has a different CSI-RS resource set that includes resources #2 and #3. Thus, by generating a separate interference measurement and sending a separate CSI report for each of the slots (e.g., the slots 606a-606c and 608a and 608b), the UE can generate separate interference measurement values and send separate CSI reports for CSI-RS resources that belong to different CSI-RS resource sets.

In additional embodiments, the UE may be configured to generate and report a corresponding single interference measurement value for multiple slots of each slot type (e.g., SBFD slot vs. non-SBFD slot). For example, the UE may report a first interference measurement value for multiple slots of a first slot type to the network 130 and report a second interference measurement value for multiple slots of a second slot type to the network 130.

For example, if the UE is configured to provide CSI reports that include an interference measurement quantity of channel state information resource indicator-reference signal received power (cri-RSRP), the UE may report a first value in the form of cri-RSRP-0 for multiple slots of the first slot type and report a second value in the form of cri-RSRP-1 for multiple slots of the second slot type.

In such an example, the first value may be generated by averaging the individual interference measurement values of the non-partitioned slots (e.g., non-partitioned slots 602a-602c) to obtain a corresponding average interference measurement value for the non-partitioned slots as the first value. Likewise, the second value may be generated by averaging the individual interference measurement values of the partitioned slots (e.g., partitioned slots 604a and 604b) to obtain a corresponding average interference measurement value for the partitioned slots as the second value.

In some instances, the UE may report an initial value for the first type of slot to the network 130, and then report a differential value to the initial value that is used by the network 130 to determine the value for the second type of slot. In such instances, the differential value may be defined relative to the first and second report values as: differentialReportValue =firstReportValue-secondReportValue

In other embodiments, the two reported interference measurement values may be included in a single CSI report. The sets of slots for which each interference measurement is generated may be indicated to the UE by a high-layer parameter, such as a parameter provided by Layer-1 or Layer-2, in which Layer-1 level refers to the physical layer in the 3GPP specifications, Layer-2 level refers to the media access control (MAC) layer in the 3GPP specifications. This proposed scheme may address the third problem associated with the current implementation of CSI reporting by SBFD UEs.

### Illustrative Implementation

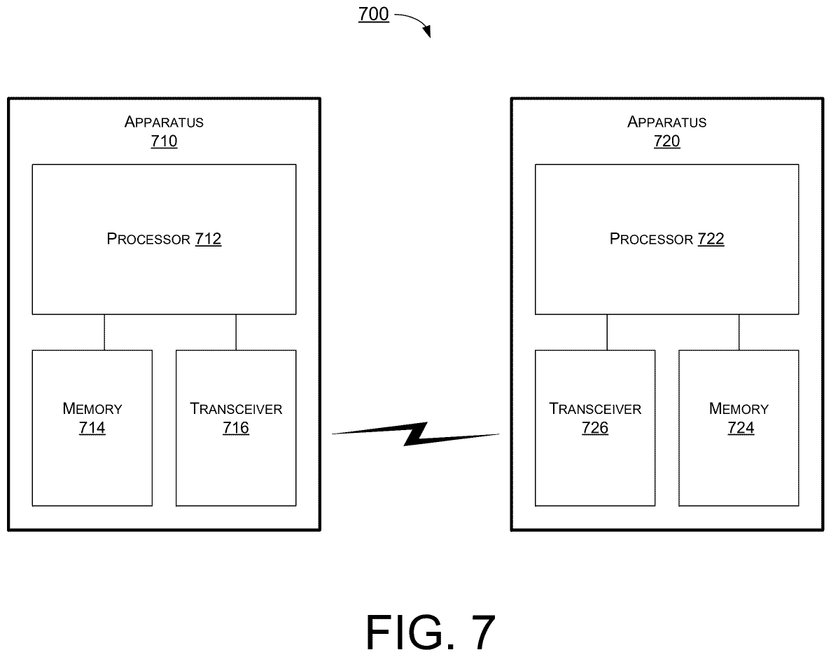

FIG. 7 illustrates an example communication system 700 having at least an example apparatus 710 and an example apparatus 720 in accordance with an implementation of the present disclosure. Each of apparatus 710 and apparatus 720 may perform various functions to implement schemes, techniques, processes and methods described herein pertaining to CSI reporting in SBFD, including the various schemes described above with respect to various proposed designs, concepts, schemes, systems and methods described above, including network environment 100, as well as processes described below.

Each of apparatus 710 and apparatus 720 may be a part of an electronic apparatus, which may be a network apparatus or a UE (e.g., UE 110), such as a portable or mobile apparatus, a wearable apparatus, a vehicular device or a vehicle, a wireless communication apparatus or a computing apparatus. For instance, each of apparatus 710 and apparatus 720 may be implemented in a smartphone, a smartwatch, a personal digital assistant, an electronic control unit (ECU) in a vehicle, a digital camera, or a computing equipment such as a tablet computer, a laptop computer or a notebook computer. Each of apparatus 710 and apparatus 720 may also be a part of a machine type apparatus, which may be an IoT apparatus such as an immobile or a stationary apparatus, a home apparatus, a roadside unit (RSU), a wire communication apparatus or a computing apparatus. For instance, each of apparatus 710 and apparatus 720 may be implemented in a smart thermostat, a smart fridge, a smart door lock, a wireless speaker or a home control center. When implemented in or as a network apparatus, apparatus 710 and/or apparatus 720 may be implemented in an eNodeB in an LTE, LTE-Advanced or LTE-Advanced Pro network or in a gNnodeB or TRP in a 5G network, a B 5G network, an NR network or an IoT network.

In some implementations, each of apparatus 710 and apparatus 720 may be implemented in the form of one or more integrated-circuit (IC) chips such as, for example and without limitation, one or more single-core processors, one or more multi-core processors, one or more complex-instruction-set-computing (CISC) processors, or one or more reduced-instruction-set-computing (RISC) processors. In the various schemes described above, each of apparatus 710 and apparatus 720 may be implemented in or as a network apparatus or a UE. Each of apparatus 710 and apparatus 720 may include at least some of those components shown in FIG. 7 such as a processor 712 and a processor 722, respectively, for example. Each of apparatus 710 and apparatus 720 may further include one or more other components not pertinent to the proposed scheme of the present disclosure (e.g., internal power supply, display device and/or user interface device), and, thus, such component(s) of apparatus 710 and apparatus 720 are neither shown in FIG. 7 nor described below in the interest of simplicity and brevity.

In one aspect, each of processor 712 and processor 722 may be implemented in the form of one or more single-core processors, one or more multi-core processors, or one or more CISC or RISC processors. That is, even though a singular term “a processor” is used herein to refer to processor 712 and processor 722, each of processor 712 and processor 722 may include multiple processors in some implementations and a single processor in other implementations in accordance with the present disclosure. In another aspect, each of processor 712 and processor 722 may be implemented in the form of hardware (and, optionally, firmware) with electronic components including, for example and without limitation, one or more transistors, one or more diodes, one or more capacitors, one or more resistors, one or more inductors, one or more memristors and/or one or more varactors that are configured and arranged to achieve specific purposes in accordance with the present disclosure. In other words, in at least some implementations, each of processor 712 and processor 722 is a special-purpose machine specifically designed, arranged, and configured to perform specific tasks including those pertaining to techniques for UE configuration and scheduling in SBFD networks in accordance with various implementations of the present disclosure.

In some implementations, apparatus 710 may also include a transceiver 716 coupled to processor 712. Transceiver 716 may be capable of wirelessly transmitting and receiving data. In some implementations, transceiver 716 may be capable of wirelessly communicating with different types of wireless networks of different radio access technologies (RATs). In some implementations, transceiver 716 may be equipped with a plurality of antenna ports (not shown) such as, for example, four antenna ports. That is, transceiver 716 may be equipped with multiple transmit antennas and multiple receive antennas for multiple-input multiple-output (MIMO) wireless communications. In some implementations, apparatus 720 may also include a transceiver 726 coupled to processor 722. Transceiver 726 may include a transceiver capable of wirelessly transmitting and receiving data. In some implementations, transceiver 726 may be capable of wirelessly communicating with different types of UEs/wireless networks of different RATs. In some implementations, transceiver 726 may be equipped with a plurality of antenna ports (not shown) such as, for example, four antenna ports. That is, transceiver 726 may be equipped with multiple transmit antennas and multiple receive antennas for MIMO wireless communications.

In some implementations, apparatus 710 may further include a memory 714 coupled to processor 712 and capable of being accessed by processor 712 and storing data therein. In some implementations, apparatus 720 may further include a memory 724 coupled to processor 722 and capable of being accessed by processor 722 and storing data therein. Each of memory 714 and memory 724 may include a type of random-access memory (RAM) such as dynamic RAM (DRAM), static RAM (SRAM), thyristor RAM (T-RAM) and/or zero-capacitor RAM (Z-RAM). Alternatively, or additionally, each of memory 714 and memory 724 may include a type of read-only memory (ROM) such as mask ROM, programmable ROM (PROM), erasable programmable ROM (EPROM) and/or electrically erasable programmable ROM (EEPROM). Alternatively, or additionally, each of memory 714 and memory 724 may include a type of non-volatile random-access memory (NVRAM) such as flash memory, solid-state memory, ferroelectric RAM (FeRAM), magnetoresistive RAM (MRAM) and/or phase-change memory.

Each of apparatus 710 and apparatus 720 may be a communication entity capable of communicating with each other using various proposed schemes in accordance with the present disclosure. For illustrative purposes and without limitation, a description of capabilities of apparatus 710, as a UE (e.g., UE 110), and apparatus 720 as a network node (e.g., network node 125) and/or another network component implementing one or more network-side functionalities described above of a network (e.g., network 130), is provided below in the context of example processes 800-1000.

### Illustrative Processes

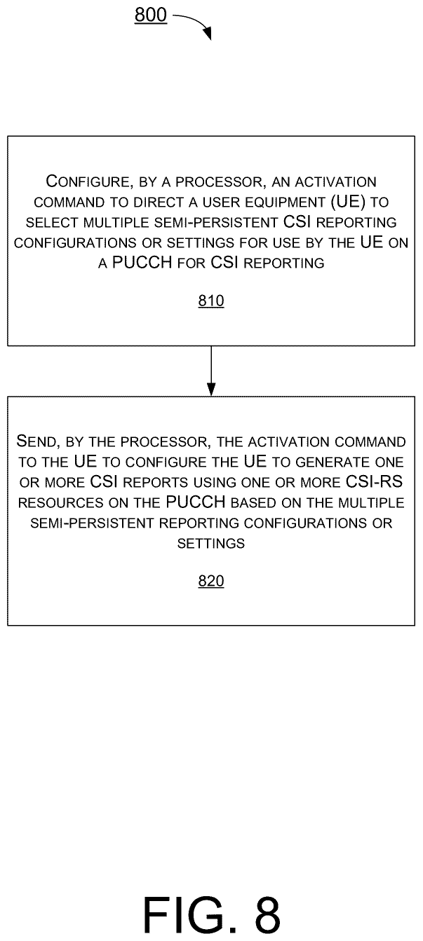

FIG. 8 is a flowchart of an example process 800 in accordance with an implementation of the present disclosure. The process 800 may represent an aspect of implementing various proposed designs, concepts, schemes, systems, and methods described above, whether partially or entirely, including those pertaining to those described above. More specifically, the process 800 may represent an aspect of the proposed concepts and schemes pertaining to CSI reporting in SBFD. The process 800 may include one or more operations, actions, or functions as illustrated by one or more blocks. Although illustrated as discrete blocks, various blocks of each process may be divided into additional blocks, combined into fewer blocks, or eliminated, depending on the desired implementation. Moreover, the blocks/sub-blocks of each process may be executed in the order shown in each figure or, alternatively in a different order. Furthermore, one or more of the blocks/sub-blocks of each process may be executed iteratively. The process 800 may be implemented by or in apparatus 710 and apparatus 720 as well as any variations thereof. Solely for illustrative purposes and without limiting the scope, the process 800 is described below in the context of apparatus 710 as a UE (e.g., UE 110) and apparatus 720 as a communication entity such as a network node or base station (e.g., network node 125 or another network node implementing one or more network-side functionalities described above) of an application server side network (e.g., network 130).

At 810, process 800 may include processor 722 of apparatus 720, implemented in or as a part of the network 130, configuring an activation command to direct a UE to select multiple semi-persistent CSI reporting configurations or settings for use by the UE on a PUCCH for CSI reporting. Process 800 may proceed from 810 to 820.

At 820, process 800 may include processor 712 sending the activation command to the UE to configure the UE to generate one or more CSI reports using one or more CSI-RS resources on the PUCCH based on the multiple semi-persistent reporting configurations or settings.

In some implementations, the activation command may be configured to direct the UE to select multiple CSI reporting configurations or settings for use by the UE on the PUCCH based on multiple slot types of the slots that includes the CSI-RS resources.

In some implementations, each CSI reporting configuration or setting of the multiple semi-persistent CSI reporting configurations or settings may be applied by the UE to a corresponding set of slots of multiple sets of slots.

In some implementations, a first CSI reporting configuration or setting of the multiple semi-persistent CSI reporting configurations or settings may be used by the UE for the CSI reporting on non-partitioned slots, and a second CSI reporting configuration or setting of the multiple semi-persistent CSI reporting configurations may be used by the UE for CSI reporting on partitioned slots. In some implementations, a slot may be a non-partitioned slot when an allocation of resource blocks in the slot for CSI reporting only overlaps with non-partitioned symbols in the slot.

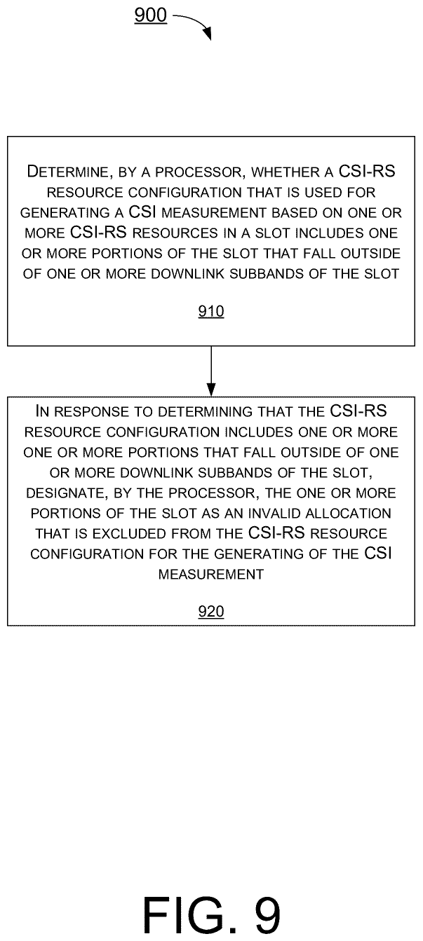

FIG. 9 is a flowchart of an example process 900 in accordance with an implementation of the present disclosure. The process 900 may represent an aspect of implementing various proposed designs, concepts, schemes, systems, and methods described above, whether partially or entirely, including those pertaining to those described above. More specifically, the process 900 may represent an aspect of the proposed concepts and schemes pertaining to CSI reporting in SBFD. The process 900 may include one or more operations, actions, or functions as illustrated by one or more blocks. Although illustrated as discrete blocks, various blocks of each process may be divided into additional blocks, combined into fewer blocks, or eliminated, depending on the desired implementation. Moreover, the blocks/sub-blocks of each process may be executed in the order shown in each figure or, alternatively in a different order. Furthermore, one or more of the blocks/sub-blocks of each process may be executed iteratively. The process 900 may be implemented by or in apparatus 710 and apparatus 720 as well as any variations thereof. Solely for illustrative purposes and without limiting the scope, the process 900 is described below in the context of apparatus 710 as a UE (e.g., UE 110) and apparatus 720 as a communication entity such as a network node or base station (e.g., network node 125 or another network node implementing one or more network-side functionalities described above) of an application server side network (e.g., network 130).

At 910, process 900 may include processor 712 of apparatus 710, implemented in or as a UE (e.g., UE 110), determining whether a channel state information-reference signal (CSI-RS) resource configuration that is used for generating a channel state information (CSI) measurement based on one or more CSI-RS resources in a slot includes one or more portions of the slot that fall outside of one or more downlink subbands of the slot. Process 900 may proceed from 910 to 920.

At 920, process 900 may include processor 712, in response to determining that the CSI-RS resource configuration includes one or more portions that fall outside of one or more downlink subbands of the slot, designating the one or more portions of the slot as an invalid allocation that is excluded from the CSI-RS resource configuration for the generating of the CSI measurement.

In some implementations, the one or more portions of the slot may fall within at least one of one or more uplink subbands or one or more guardbands of the slot. In some implementations, the CSI-RS resource configuration may be contiguous within a downlink subband of the slot when the CSI-RS resource configuration does not include the one or more portions. In some implementations, the CSI-RS resource configuration may include multiple non-contiguous downlink subbands of the slot. In some implementations, the one or more portions of the slot being excluded from the CSI-RS resource configuration as the invalid allocation may result in the CSI-RS resource configuration including multiple non-contiguous downlink subbands.

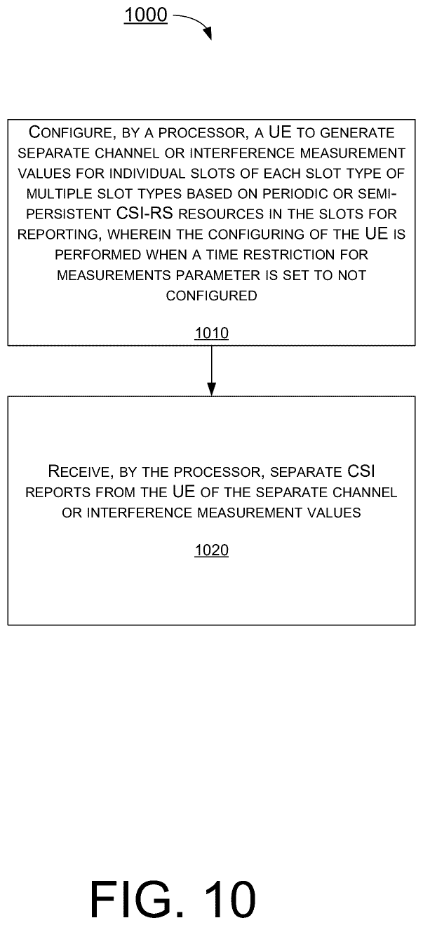

FIG. 10 is a flowchart of an example process 1000 in accordance with an implementation of the present disclosure. The process 1000 may represent an aspect of implementing various proposed designs, concepts, schemes, systems, and methods described above, whether partially or entirely, including those pertaining to those described above. More specifically, the process 1000 may represent an aspect of the proposed concepts and schemes pertaining to CSI reporting in SBFD. The process 1000 may include one or more operations, actions, or functions as illustrated by one or more blocks. Although illustrated as discrete blocks, various blocks of each process may be divided into additional blocks, combined into fewer blocks, or eliminated, depending on the desired implementation. Moreover, the blocks/sub-blocks of each process may be executed in the order shown in each figure or, alternatively in a different order. Furthermore, one or more of the blocks/sub-blocks of each process may be executed iteratively. The process 1000 may be implemented by or in apparatus 710 and apparatus 720 as well as any variations thereof. Solely for illustrative purposes and without limiting the scope, the process 1000 is described below in the context of apparatus 710 as a UE (e.g., UE 110) and apparatus 720 as a communication entity such as a network node or base station (e.g., network node 125 or another network node implementing one or more network-side functionalities described above) of an application server side network (e.g., network 130).

At 1010, process 1000 may include processor 722 of apparatus 720, implemented in or as a part of the network 130, configuring a UE to generate separate channel or interference measurement values for individual slots of each slot type of multiple slot types based on periodic or semi-persistent CSI-RS resources in the slots for reporting, wherein the configuring of the UE is performed when a time restriction for measurements parameter is set to not configured. Process 1000 may proceed from 1010 to 1020.

At 1020, process 1000 may include processor 722 receiving separate CSI reports from the UE of the separate channel or interference measurement values.

In some implementations, the time restriction for measurements parameter is a timeRestrictionForChannelMeasurements parameter when the UE is configured to generate the separate channel measurement values for the individual slots, and wherein the time restriction for measurements parameter is a timeRestrictionForInterferenceMeasurements parameter when the UE is configured to generate the separate interference measurement values for the individual slots.

In some implementations, the configuring may include configuring the UE to generate the separate channel or interference measurement values for the individual slots of a partitioned slot type and the individual slots of a non-partitioned slot type in a configured periodicity. In some implementations, a slot may be a non-partitioned slot when an allocation of resource blocks in the slot for CSI reporting only overlaps with non-partitioned symbols in the slot.

In some implementations, the configuring may include configuring the UE to generate the separate channel or interference measurement values based on periodic or semi-persistent CSI-RS resources that belong in a same CSI-RS resource set or different CSI-RS resource sets.

In some implementations, process 1000 may further include the processor 722 configuring the UE to generate and report a corresponding single channel or interference measurement value for multiple slots of each slot type of the multiple slot types, and receiving a CSI report of the corresponding single channel or interference measurement value for the multiple slots of each slot type.

In some implementations, the configuring the UE to generate and report a corresponding single channel or interference measurement value may include generating and reporting a first channel or interference measurement value for a first set of multiple slots of a first slot type and generating and reporting a second channel or interference measurement value for a second set of multiple slots of a second slot type.

In some implementations, the reporting of the first channel or interference value and the second channel or interference value may include reporting an initial value as the first channel or interference value and reporting a differential value to the first channel or interference value that is used to determine the second channel or interference value.

In some implementations, the reporting may include reporting the first channel or interference value and the second channel or interference value in a single CSI report. In some implementations, the configuring may include configuring the UE to generate the separate channel or interference measurement values for a particular set of slots using a high-layer parameter.

### Additional Notes

The herein-described subject matter sometimes illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

Further, with respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

Moreover, it will be understood by those skilled in the art that, in general, terms used herein, and especially in the appended claims, e.g., bodies of the appended claims, are generally intended as “open” terms, e.g., the term “including” should be interpreted as “including but not limited to,” the term “having” should be interpreted as “having at least,” the term “includes” should be interpreted as “includes but is not limited to,” etc. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an,” e.g., “a” and/or “an” should be interpreted to mean “at least one” or “one or more;” the same holds true for the use of definite articles used to introduce claim recitations. In addition, even if a specific number of an introduced claim recitation is explicitly recited, those skilled in the art will recognize that such recitation should be interpreted to mean at least the recited number, e.g., the bare recitation of “two recitations,” without other modifiers, means at least two recitations, or two or more recitations. Furthermore, in those instances where a convention analogous to “at least one of A, B, and C, etc.” is used, in general such a construction is intended in the sense one having skill in the art would understand the convention, e.g., “a system having at least one of A, B, and C” would include but not be limited to systems that have A alone, B alone, C alone, A and B together, A and C together, B and C together, and/or A, B, and C together, etc. In those instances where a convention analogous to “at least one of A, B, or C, etc.” is used, in general such a construction is intended in the sense one having skill in the art would understand the convention, e.g., “a system having at least one of A, B, or C” would include but not be limited to systems that have A alone, B alone, C alone, A and B together, A and C together, B and C together, and/or A, B, and C together, etc. It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

From the foregoing, it will be appreciated that various implementations of the present disclosure have been described herein for purposes of illustration, and that various modifications may be made without departing from the scope and spirit of the present disclosure. Accordingly, the various implementations disclosed herein are not intended to be limiting, with the true scope and spirit being indicated by the following claims.

What is claimed is:

1. A method, comprising:
configuring, by a processor, an activation command to direct a user equipment (UE) to select multiple semi-persistent channel state information (CSI) reporting configurations or settings for use by the UE on a physical uplink control channel (PUCCH) for CSI reporting; and
sending, by the processor, the activation command to the UE to configure the UE to generate one or more CSI reports using one or more channel state information-reference signal (CSI-RS) resources on the PUCCH based on the multiple semi-persistent reporting configurations or settings.

2. The method of claim 1, wherein the activation command is configured to direct the UE to select multiple CSI reporting configurations or settings for use by the UE on the PUCCH based on multiple slot types of the slots that include the CSI-RS resources.

3. The method of claim 1, wherein each CSI reporting configuration or setting of the multiple semi-persistent CSI reporting configurations or settings is applied by the UE to a corresponding set of slots of multiple sets of slots.

4. The method of claim 1, wherein a first CSI reporting configuration or setting of the multiple semi-persistent CSI reporting configurations or settings is used by the UE for the CSI reporting on non-partitioned slots, and a second CSI reporting configuration or setting of the multiple semi-persistent CSI reporting configurations is used by the UE for CSI reporting on partitioned slots.

5. The method of claim 4, wherein a slot is a non-partitioned slot when an allocation of resource blocks in the slot for CSI reporting only overlaps with non-partitioned symbols in the slot.

6. An apparatus, comprising:
a transceiver configured to communicate wirelessly; and
a processor coupled to the transceiver and configured to perform operations comprising:
determining whether a channel state information-reference signal (CSI-RS) resource configuration that is used for generating a channel state information (CSI) measurement based on one or more CSI-RS resources in a slot includes one or more portions of the slot that fall outside of one or more downlink subbands of the slot; and
in response to determining that the CSI-RS resource configuration includes one or more portions that fall outside of one or more downlink subbands of the slot, designating the one or more portions of the slot as an invalid allocation that is excluded from the CSI-RS resource configuration for the generating of the CSI measurement.

7. The apparatus of claim 6, wherein the one or more portions of the slot fall within at least one of one or more uplink subbands or one or more guardbands of the slot.

8. The apparatus of claim 6, wherein the CSI-RS resource configuration is contiguous within a downlink subband of the slot when the CSI-RS resource configuration does not include the one or more portions.

9. The apparatus of claim 6, wherein the CSI-RS resource configuration includes multiple non-contiguous downlink subbands of the slot.

10. The apparatus of claim 6, wherein the one or more portions of the slot being excluded from the CSI-RS resource configuration as the invalid allocation results in the CSI-RS resource configuration including multiple non-contiguous downlink subbands.

11. A method, comprising:
configuring, by a processor, a UE to generate separate channel or interference measurement values for individual slots of each slot type of multiple slot types based on periodic or semi-persistent channel state information-reference signal (CSI-RS) resources in the slots for reporting; and
receiving, by the processor, separate channel state information (CSI) reports from the UE of the separate channel or interference measurement values,
wherein the configuring is performed when a time restriction for measurements parameter is set to not configured.

12. The method of claim 11, wherein the time restriction for measurements parameter is a timeRestrictionForChannelMeasurements parameter when the UE is configured to generate the separate channel measurement values for the individual slots, and wherein the time restriction for measurements parameter is a timeRestrictionForInterferenceMeasurements parameter when the UE is configured to generate the separate interference measurement values for the individual slots.

13. The method of claim 11, wherein the configuring includes configuring the UE to generate the separate channel or interference measurement values for the individual slots of a partitioned slot type and the individual slots of a non-partitioned slot type in a configured periodicity.

14. The method of claim 13, wherein a slot is a non-partitioned slot when an allocation of resource blocks in the slot for CSI reporting only overlaps with non-partitioned symbols in the slot.

15. The method of claim 13, wherein the configuring includes configuring the UE to generate the separate channel or interference measurement values based on periodic or semi-persistent CSI-RS resources that belong in a same CSI-RS resource set or different CSI-RS resource sets.

16. The method of claim 13, further comprising:
configuring the UE to generate and report a corresponding single channel or interference measurement value for multiple slots of each slot type of the multiple slot types; and
receiving a CSI report of the corresponding single channel or interference measurement value for the multiple slots of each slot type.

17. The method of claim 16, wherein the configuring the UE to generate and report a corresponding single channel or interference measurement value includes generating and reporting a first channel or interference measurement value for a first set of multiple slots of a first slot type and generating and reporting a second channel or interference measurement value for a second set of multiple slots of a second slot type.

18. The method of claim 17, wherein the reporting of the first channel or interference value and the second channel or interference value includes reporting an initial value as the first channel or interference value and reporting a differential value to the first channel or interference value that is used to determine the second channel or interference value.

19. The method of claim 17, wherein the reporting includes reporting the first channel or interference value and the second channel or interference value in a single CSI report.

20. The method of claim 11, wherein the configuring includes configuring the UE to generate the separate channel or interference measurement values for a particular set of slots using a high-layer parameter.
